(19) United States
(12) Patent Application Publication
(10) Pub. No.: US 2024/0255402 A1
(43) Pub. Date: Aug. 1, 2024

(54) SYSTEMS AND METHODS FOR DETERMINING MATERIAL CONSTITUTIVE MODEL PARAMETERS

(71) Applicant: The Texas A&M University System, College Station, TX (US)

(72) Inventors: Dinakar Sagapuram, College Station, TX (US); Harshit Chawla, College Station, TX (US); Hrayer Aprahamian, College Station, TX (US)

(73) Assignee: The Texas A&M University System, College Station, TX (US)

(21) Appl. No.: 18/565,855

(22) PCT Filed: Jun. 3, 2022
(86) PCT No.: PCT/US2022/032206

§ 371 Date: Nov. 30, 2023

Related U.S. Application Data
(60) Provisional application No. 63/196,567, filed on Jun. 3, 2021.

(51) Int. Cl. G01N 3/42; G01N 3/06; G01N 3/58

(52) U.S. Cl. CPC G01N 3/42; G01N 3/068; G01N 3/58; G01N 2203/0082; G01N 2203/0647; G01N 2203/0694

(57) ABSTRACT

A method for determining constitutive parameters of a subject material includes collecting a force sensor output from a force sensor unit for measuring reactive forces applied to a deformation tool from a subject material travelling in a predefined direction relative to the deformation tool, collecting an image sequence output from a camera unit depicting a deformation zone formed between the deformation tool and the subject material as the subject material is plastically deformed by the deformation tool, and estimating a constitutive parameter of the subject material based on the force sensor output and the image sequence output.

### CROSS-REFERENCE TO RELATED APPLICATIONS

This application claims benefit of U.S. provisional patent application Ser. No. 63/196,567 filed Jun. 3, 2021, and entitled “Systems and Methods for Determining Material Constitutive parameters,” which is hereby incorporated herein by reference in its entirety for all purposes.

### STATEMENT REGARDING FEDERALLY SPONSORED RESEARCH OR DEVELOPMENT

Not applicable.

### BACKGROUND

This disclosure relates to systems and methods for determining constitutive parameters for different subject materials. A constitutive model or law of a subject material represents a functional relationship between different deformation-related constitutive parameters that quantitatively describe how the subject material responds to external mechanical loading. Characterization of each of the constitutive parameters of a constitutive model associated with a given material is critical for understanding the manner in which a material deforms under external loads during various stages of the material's lifecycle moving from the formation or fabrication of the material to the final intended application.

### BRIEF SUMMARY OF THE DISCLOSURE

An embodiment of a system for determining constitutive parameters of a subject material comprises a testbed having an external surface configured to receive the subject material to couple the subject material to the testbed, a linear drive configured to transport the subject material, when coupled to the testbed, in a predefined direction at a predefined velocity, a deformation tool configured to physically contact and plastically deform the subject material in response to the transportation of the subject material in the predefined direction by the linear drive, a force sensor unit coupled to the deformation tool and configured to produce a force sensor output corresponding to reactive forces applied to the deformation tool from the subject material, a camera unit configured to produce an image sequence output of a deformation zone formed between the deformation tool and the subject material in response to plastic deformation of the subject material by the deformation tool, and a computer system coupled to the force sensor unit and the camera unit and comprising a parameter estimation module configured to estimate a constitutive parameter of the subject material based on the force sensor output and the image sequence output. In some embodiments, the camera unit comprises a magnification lens and a camera coupled the magnification lens. In some embodiments, the camera unit comprises a thermal sensor for monitoring a temperature of the deformation zone. In certain embodiments, the deformation tool comprises at least one of an indenter, and a cutting tool having a cutting face configured to cut into the subject material at a predefined rake angle. In certain embodiments, the parameter estimation module of the computer system is configured to determine a measured plastic work based on the force sensor output and the image sequence output and a predicted plastic work based on a selected constitutive model, and to compare the measured plastic work with the predicted plastic work. In some embodiments, the parameter estimation module of the computer system is configured to provide an initial estimate of the constitutive parameter, and wherein the predicted plastic work is based on the initial estimate and the image sequence output. In some embodiments, the parameter estimation module of the computer system is configured to minimize an error between the predicted plastic work and the measured plastic work. In some embodiments, the parameter estimation module of the computer system is configured to apply a Newton-Raphson algorithm to an objective function defining the error between the predicted plastic work and the measured plastic work to minimize the error. In certain embodiments, the parameter estimation module of the computer system is configured to apply a spatial Branch-and-Bound to an objective function defining the error between the predicted plastic work and the measured plastic work to minimize the error. In certain embodiments, the computer system comprises an image correlation module configured to apply an image correlation algorithm to the image sequence output to produce a velocity field sequence from the image sequence output. In some embodiments, the image correlation module is configured to determine a plastic strain rate field of the deformation zone based on the application of the image correlation algorithm to the image sequence output. In some embodiments, the constitutive parameter comprises at least one of a yield strength, a hardening modulus, a strain-rate sensitivity, a strain-hardening, and a thermal-softening of the subject material.

An embodiment of a method for determining constitutive parameters of a subject material comprises (a) collecting a force sensor output from a force sensor unit for measuring reactive forces applied to a deformation tool from a subject material travelling in a predefined direction relative to the deformation tool, (b) collecting an image sequence output from a camera unit depicting a deformation zone formed between the deformation tool and the subject material as the subject material is plastically deformed by the deformation tool, and (c) estimating a constitutive parameter of the subject material based on the force sensor output and the image sequence output. In some embodiments, the image sequence output at least one of visually depicts the deformation zone and thermally depicts the deformation zone. In some embodiments, (c) comprises (c1) determining a measured plastic work based on the force sensor output, (c2) determining a predicted plastic work based on a selected constitutive model, the image sequence output, and an initial estimate of the constitutive parameter, and (c3) comparing the measured plastic work with the predicted plastic work. In some embodiments, (c3) comprises minimizing an error between the predicted plastic work and the measured plastic work by iteratively adjusting the values of the constitutive parameters. In certain embodiments, (c) comprises (c1) selecting a constitutive law based on the identity of the subject material, (c2) tailoring an optimization algorithm based on the selected constitutive law, and (c3) applying the tailored optimization algorithm to an objective function defining an error between a predicted plastic work determined from the force sensor output and a measured plastic work determined from the selected constitutive model, the image sequence output, and an initial estimate of the constitutive parameter to minimize the error. In some embodiments, the image sequence output depicts a strain rate of the subject material of 102 per second or greater.

An embodiment of a computer system for determining constitutive parameters of a subject material comprising a processor, and a storage device coupled to the processor and containing instructions that when executed cause the processor to collect a force sensor output from a force sensor unit for measuring reactive forces applied to a deformation tool from a subject material travelling in a predefined direction relative to the deformation tool, collect an image sequence output from a camera unit depicting a deformation zone formed between the deformation tool and the subject material as the subject material is plastically deformed by the deformation tool, and estimate a constitutive parameter of the subject material based on the force sensor output and the image sequence output.

### BRIEF DESCRIPTION OF THE DRAWINGS

For a detailed description of exemplary embodiments of the disclosure, reference will now be made to the accompanying drawings in which:

FIG. 1 is a schematic perspective view of an embodiment of a system for determining constitutive parameters of a subject material;

FIG. 2 is a side view of an embodiment of a deformation tool of the system of FIG. 1;

FIG. 3 is a side view of another embodiment of a deformation tool of the system of FIG. 1;

FIG. 4 is a side view of another embodiment of a deformation tool of the system of FIG. 1;

FIG. 5 is a side view of another embodiment of a deformation tool of the system of FIG. 1;

FIG. 6 is a side view of another embodiment of a deformation tool of the system of FIG. 1;

FIG. 7 is a side view of another embodiment of a deformation tool of the system of FIG. 1;

FIG. 8 is a side view of another embodiment of a deformation tool of the system of FIG. 1;

FIG. 9 is a block diagram of an embodiment of an image correlation module of the system of FIG. 1;

FIG. 10 is a block diagram of an embodiment of a parameter estimation module of the system of FIG. 1;

FIG. 11 is a diagram of a displacement field sequence of the system of FIG. 1;

FIG. 12 is a block diagram of an embodiment of a method for determining constitutive parameters of a subject material;

FIG. 13 is a graph illustrating cutting and thrust forces overtime;

FIG. 14 is a graph illustrating sum of squared residuals (SSR) as a function of constitutive parameters of a subject material;

FIG. 15 is a graph illustrating the SSR as a function of a single constitutive parameter;

FIG. 16 is a graph illustrating incremental work as a function of time;

FIG. 17 is a graph illustrating flow stress of a subject material as a function of strain;

FIG. 18 is a graph illustrating cutting and thrust forces over time;

FIGS. 19 and 20 are graphs illustrating convergence of SSR over a plurality of iterations for a first regime of a constitutive parameter;

FIGS. 21 and 22 are graphs illustrating convergence of SSR over a plurality of iterations for a second regime of a constitutive parameter;

FIG. 23 is a graph illustrating incremental work as a function of time; and

FIGS. 24 and 25 are graphs illustrating flow stress of a subject material as a function of strain and strain rate.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

As described above, constitutive laws or models are functional relationships between mechanical quantities such as stress, strain, strain rate (i.e., rate of loading), strain path, temperature, etc., that describe the mechanical behavior of a subject material when the material is subjected to external loading or deformation. For example, a constitutive law may describe how the flow stress of a subject material like metal or an alloy depends on the external loading conditions like strain, strain rate and temperature. To state in other words, a constitutive law permits for the flow stress of the subject material to be represented as a function of these latter three parameters. The coefficients, powers or exponents that enter into a constitutive law such as the exemplary function outlined above are referred to herein as “constitutive parameters”. For instance, similar materials may be described using a same constitutive law but will differ in terms of the specific constitutive parameters.

Generally, constitutive parameters of different subject materials may be determined experimentally through conducting a series of separate experiments on the subject material and/or the constitutive parameters may be predicted by assuming a constitutive model for the subject material and fitting or calibrating that model using experimental data collected from the series of experiments. Depending on the material type (metal, polymer, etc.), constitutive models can be complex having constitutive parameters that are determined from a series of experimental observations of the material's response over a wide range of controlled loading conditions. As the complexity of constitutive model and number of constitutive parameters increase, requirements regarding the number and types of experiments, test data, and samples of the subject material increase accordingly. The experimental time required for identifying the constitutive parameters thus also increases substantially. Furthermore, to characterize the material response under high rates of deformation (e.g., strain rates greater than 10 per second (/s)), special experimental techniques involving gas guns or explosive mechanisms are often required.

Accordingly, embodiments disclosed herein for determining one or more constitutive parameters for different types of subject materials (e.g., metals, polymers, etc.). The systems and methods described herein avoid finite element methods and the forming of assumptions regarding flow kinematics or the nature of the deformation zone (e.g., stress and strain uniformity), and instead integrates direct observations of the subject material under plastic flow or deformation into a framework for determining one or more constitutive parameters of the subject material. For example, systems described herein include a force sensor unit for monitoring reactive forces applied to deformation tool for plastically deforming the subject material, and a camera unit for directly observing the deformation zone as the subject material is plastically deformed by the deformation tool and acquiring imaging data as an image sequence output. It may be understood that the imaging data acquired by the camera unit may be visual and/or nonvisual. In other words, the imaging data may fall at least partially within the visible portion of the electromagnetic spectrum and/or other portions of the electromagnetic spectrum which fall outside of the visible portion.

Systems and methods described herein allow for the determination of a plurality of constitutive parameters of a subject material following the conduction of a single experiment in which plastic deformation of the subject material is captured by the force sensor unit and camera unit. For example, a deformation tool plastically deforming the subject material a single time (e.g., a single indentation or a single cut made to the subject material) may provide sufficient data to the force sensor and camera units to permit systems described herein to determine each of the constitutive parameters of the subject material to fully calibrate a constitutive law or model associated with the identify or type of the subject material. Additionally, the single deformation may be performed at an extremely broad range of plastic strains (e.g., up to 1000% or more), strain rates (quasi-static to rates up to or exceeding 10⁵ per second), and temperatures. Further, systems and methods described herein are not limited to one type of subject material and instead may be utilized to determine the constitutive parameters of a broad range of subject materials including metals, alloys, polymers, etc., formed using a variety of fabrication techniques.

Data from the force sensor unit and an image sequence provided by the camera unit act as inputs for a computer system configured to determine or estimate one or more constitutive parameters of the subject material based on the force sensor output and the image sequence output. The computer system may compare an experimentally observed plastic work performed on the subject material with a predicted plastic work to determine the one or more constitutive parameters. For example, the computer system may minimize an error between the measured plastic work with the predicted plastic work to determine the one or more constitutive parameters. In minimizing the error, the computer system may apply an optimization algorithm to an objective function defining the error between the measured plastic work and the predicted plastic work to achieve a globally optimum solution. The optimization algorithm applied by the computer system may vary depending on the given embodiment and application. As one example, the computer system may apply a Newton-Raphson algorithm or a spatial Branch-and-Bound algorithm to the objective function to minimize the error between the observed plastic work and the predicted plastic work.

Additionally, the parameter estimation module may select a constitutive law or model associated with the identity or type of subject material, and tailor the optimization algorithm based on the selected constitutive law such that the tailored optimization algorithm may achieve a globally optimal solution to the objective function and thereby achieve an accurate and precise determination of the constitutive parameters of the subject material. This is in contrast to generic optimization algorithms such as generic Newton-based algorithms which may only achieve a locally, and not a globally, optimal solution leading to parameter estimates which are inaccurate.

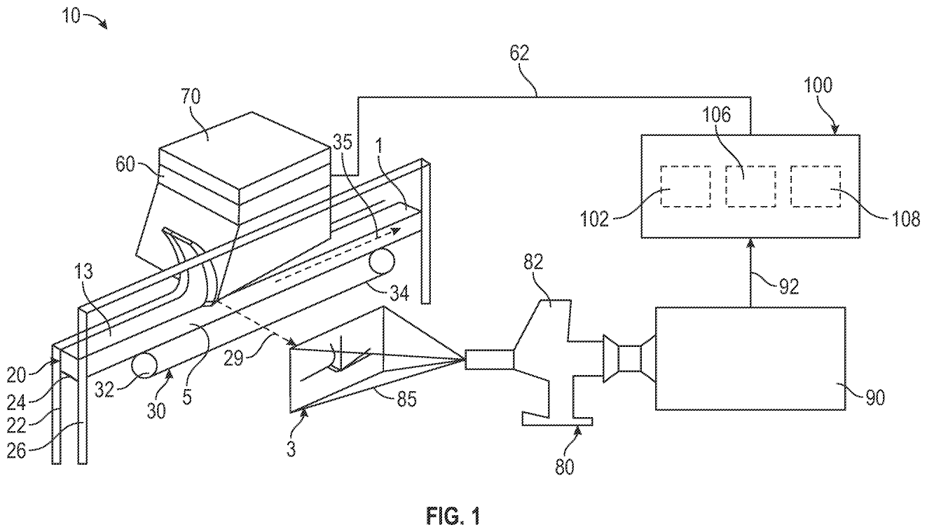

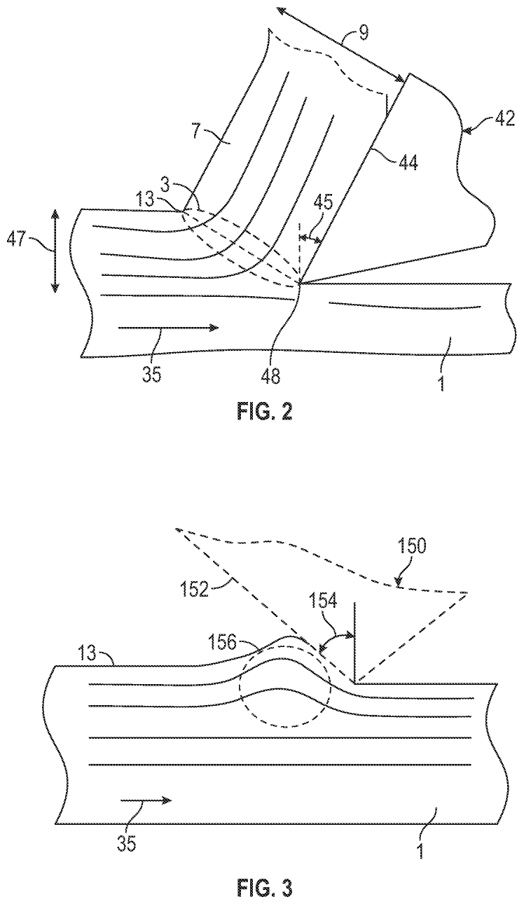

Referring initially to FIGS. 1 and 2, an embodiment of a system 10 for determining constitutive parameters of a subject material is shown schematically. As will be described herein, system 10 permits for the capture of experimental data associated with a workpiece or subject material 1 from which deformation-related parameters of the subject material may be estimated by the system 10 without reliance on preexisting information pertaining to the type and nature of the subject material 1. The configuration of subject material 1 may vary depending on the given application. For example, subject material 1 may comprise a metal, an alloy, and a polymer. In this exemplary embodiment, system 10 generally includes a workpiece testbed 20, a deformation assembly 40, a camera unit 80, and a computer system 100.

The workpiece testbed 20 of system 10 secures and positions the subject material 1 relative to the camera unit 80. Additionally, in this exemplary embodiment, workpiece testbed 20 transports the subject material 1 relative to the deformation assembly 40; however, it may be understood that in other embodiments workpiece testbed 20 may hold subject material 1 stationary as deformation assembly 40 travels (in one or more different directions) relative to the subject material 1 and workpiece testbed 20. In this exemplary embodiment, workpiece testbed 20 generally includes a support structure or bed 22 upon which the subject material 1 may be positioned, a transparent plate 26 positioned adjacent the support bed 22, and a linear drive 30.

Particularly, support bed 22 of workpiece testbed 20 defines an elongate support surface 24 upon which the subject material 1 may be positioned. Support surface 24 is generally planar in this exemplary embodiment but may vary in other embodiments depending upon the configuration of workpiece testbed 20 and subject material 1. Linear drive 30 is coupled to the support bed 22 and is configured to transport the subject material 1 in a defined deformation direction (indicated by arrow 35 in FIG. 1) across the support surface 24 of support bed 22. Linear drive 30 may be in signal communication with computer system 100 whereby computer system 100 may monitor the operation of linear drive 30 (e.g., the current speed of subject material 1 in the deformation direction 35) and/or control the operation of linear drive 30. For example, in this exemplary embodiment, linear drive 30 comprises an electric motor 32 which may be connected to the computer system 100. Electric motor 32 operates a transport member or belt 34 which physically contacts the subject material 1 and transports the subject material 1 along the support bed 22. It may be understood that the configuration of linear drive 30 may vary in other embodiments. For example, in other embodiments, the configuration of transport member 34 may vary in other embodiments.

Transparent plate 26 is relatively thin and planar in configuration in this exemplary embodiment, and is positioned along one of the sides of the support bed 22 such that transparent plate 26 is positioned between the subject material 1 and the camera unit 80. In this configuration, light reflecting off of the subject material 1 and deformation assembly 40 passes entirely though the transparent plate 26 (indicated by arrow 29 in FIG. 1) before it is captured by the camera unit 80. In this exemplary embodiment, transparent plate 26 comprises a transparent sapphire material, however, in other embodiments, transparent plate 26 may comprise other transparent materials such as glass.

Transparent plate 26 allows the camera unit 80 to capture deformation (e.g., material flow) of the subject material 1 which occurs within a deformation zone 3 in two-dimensions (2D). Particularly, transparent plate 26 abuts or is positioned flush against a lateral side 5 of the subject material 1 such that transparent plate 26 physically constrains out-of-plate flow of the subject material 1 within the deformation zone 3, ensuring the images captured by camera unit 80 are focused on a single image plane. In this manner, observations of the deformation zone 3 are representative of the bulk (through-thickness) behavior of subject material 1.

Deformation assembly 40 of system 10 plastically deforms at least a portion of the subject material 1 supported on the workpiece testbed 20 such that the plastic deformation of subject material 1 may be captured in 2D by the camera unit 80. In this exemplary embodiment, deformation assembly 40 generally includes a deformation tool 42, a force sensor unit 60, and a mount 70. In this exemplary embodiment, deformation tool 42 comprises a cutting tool or wedge and thus may also be referred to herein as cutting tool 42. Cutting tool 42 may be formed from a high-strength cutting tool steel or carbide material.

As shown particularly in FIG. 2, cutting tool 42 comprises a cutting face 44 such that a rake angle 45 is formed between the cutting face 44 of cutting tool 42 and the subject material 1 when subject material 1 is transported in the predefined direction 35 by linear drive 30 at a predefined cutting velocity which may vary substantially based on the application from a few micrometers per second (μm/s) to speeds at or above 20 meters per second (m/s). The amount of interference between the cutting tool 42 and the subject material 1 is represented by the cutting depth 47 as well as the properties of subject material 1. Interference between cutting tool 42 and the subject material 1 results in the formation of a cutting chip 7 having a chip thickness 9 dependent on the cutting depth 47. It may be understood that when the cutting face 44 of cutting tool 42 is generally perpendicular to the cutting direction 35 and the cutting depth 47 is relatively small compared to the width of the cut, a state of 2D deformation and flow generally prevails.

In this exemplary embodiment, the deformation field formed in cutting of the subject material 1 is characterized by large shear that is imposed in the small deformation zone 3 that extends from a tip 48 of the cutting tool 42 to a free surface 13 of the subject material 1. Generally, a sharp transition in the microstructure of subject material 1 from an initial equiaxed structure to a flow-line structure is produced in the deformation zone 3, indicative of relatively large plastic deformation of the subject material 1 as the subject material 1 passes through the deformation zone 3.

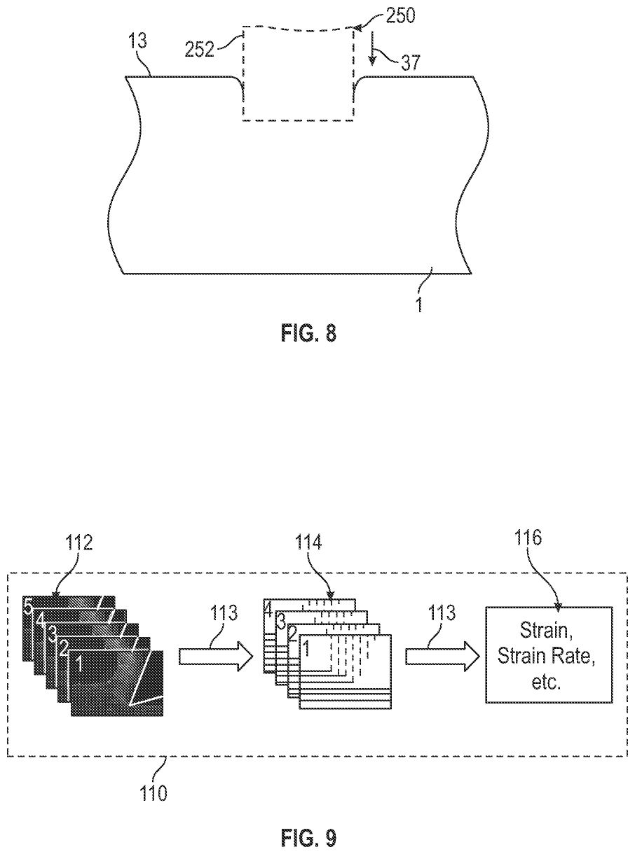

Although in this exemplary embodiment the deformation assembly 40 comprises a cutting tool 42, in other embodiments, deformation assembly 40 may not include a cutting tool and may not separate a portion of the subject material 1 from itself in the form of a chip. For example, referring briefly to FIGS. 3-8, other embodiments of deformation tools 150, 170, 190, 210, 230, and 250, respectively, are shown. Deformation tools 150, 170, 190, 210, 230, and 250 may be used in lieu of the cutting tool 42 for the deformation assembly 40. In this exemplary embodiment, deformation tools 150, 170, 190, 210, 230, and 250 each comprise indenters (and may be referred to as such herein) configured to plastically deform subject material 1 along and in a deformation zone. For example, the indenter 150 shown in FIG. 3 plastically deforms the subject material 1 in response to the subject material 1 travelling in the deformation direction 35. Particularly, indenter 150 comprises a generally planar deforming face 152 which contacts and rubs linearly along the free surface 13 of subject material at a rank angle 154, thereby plastically deforming subject material 1 in a deformation zone 156 formed in the subject material 1.

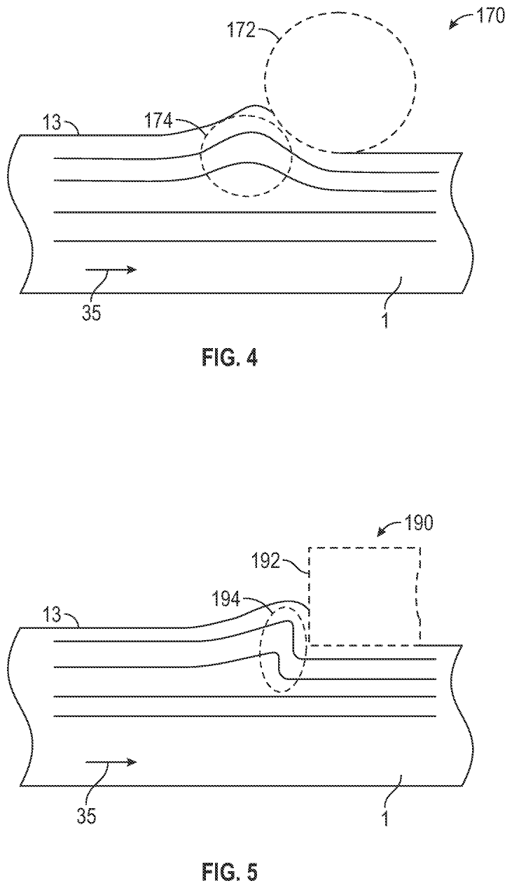

Indenter 170 shown in FIG. 4 comprises a curved element having a generally circular deforming face 172. For example, indenter 170 may comprise a cylindrical roller, a spherical rolling element, etc. The circular deforming face 172 may rub along (being prevented from rotating relative to the subject material 1) the free surface 13 of the subject material 1 to thereby plastically deform the subject material 1 in a deformation zone 174 formed in the subject material 1 in response to physical contact between the indenter 170 and the subject material 1 travelling in the deformation direction 35. Indenter 190 of FIG. 5 comprises a rectangular element having a generally planar deforming face 172 oriented perpendicular to the deformation direction 35 of subject material 1. In this configuration, deforming face 192 may rub along the free surface 13 of the subject material 1 to thereby plastically deform the subject material 1 in a deformation zone 194 formed in the subject material 1 in response to physical contact between the indenter 190 and the subject material 1 travelling in the deformation direction 35.

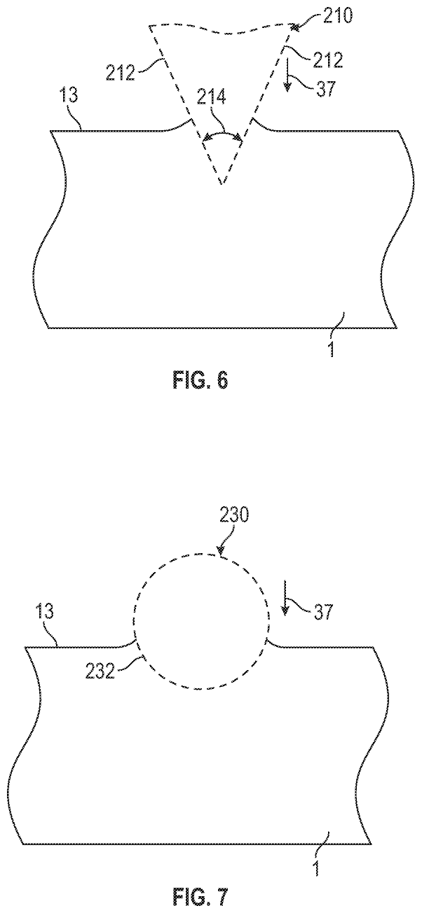

Indenter 210 of FIG. 6 comprises a pair of generally planar deforming faces 212 oriented at an angle 214 relative to each other. Deforming faces 212 indent into the free surface 13 of subject material 1 in response to indenter 210 travelling along a second or orthogonal deforming direction 37 (oriented orthogonal to the first deforming direction 35) relative to the subject material 1. Indenter 230 of FIG. 7 having a generally circular deforming face 232 is similar in configuration to indenter 170 described above. Additionally, indenter 250 having a generally planar deformation face 252 is similar in configuration to the indenter 190 described above. However, indenters 230 and 250 are configured to plastically deform the subject material 1 in response to travelling to the second deformation direction 37. It may be understood that indenters 150, 170, 190, 210, 230, and 250 are only a limited selection of examples.

Referring again to FIGS. 1 and 2, the cutting tool 42 of deformation assembly 40 is coupled to both force sensor unit 60 and tool mount 70. Tool mount 70 secures the position of cutting tool 42 relative to workpiece testbed 20 such that cutting tool 42 only travels along a desired predefined deformation direction (e.g., directions 35 and/or 37) at a desired predefined velocity (e.g., the deformation velocity) relative to the subject material 1. Force sensor unit 60 is coupled to cutting tool 42 (e.g., between cutting tool 42 and tool mount 70) and is configured to monitor reactive forces applied to the cutting tool 42 from the subject material 1 as the cutting tool 42 plastically deforms the subject material 1 in response to the material 1 travelling in the first deformation direction 35.

Force sensor unit 60 is coupled to and in signal communication with the computer system 100 such that force sensor unit 60 may provide computer system 100 with tool sensor data (indicated as force sensor output 62 in FIG. 1) as will be described further herein. In this exemplary embodiment, force sensor unit 60 comprises one or more piezoelectric sensors configured to produce a voltage output in response to the production of strain in a piezoelectric element or film of the sensor. For example, in some embodiments, force sensor unit 60 comprises a piezoelectric, force dynamometer (e.g., a force dynamometer produced by the Kistler Group of Winterthur, Switzerland) configured to measure cutting forces (F_{c}) applied to the cutting tool 42 parallel to the deformation direction 35. Additionally, force sensor unit may measure thrust forces (Fₜ) applied to the cutting tool 42 and which act perpendicular to the deformation direction 35. Force sensor unit 60 may have a high sampling rate of 100 kilohertz (kHz) or more for measuring the cutting forces at high frequencies.

The camera unit 80 of system 10 captures imaging data of the cutting process and provides the captured imaging data in the form of an image sequence output 92 of the cutting process to the computer system 100 which is coupled to and in signal communication with the camera unit 80. It may be understood that the imaging data captured by camera unit 80 may be from any portion of the electromagnetic spectrum. Thus, the imaging data captured by camera unit 80 may or may not fall within the visible portion of the electromagnetic spectrum. In this exemplary embodiment, camera unit 80 generally includes a magnification lens 82 and a high-speed camera 90 coupled to the magnification lens 82. In some embodiments, magnification lens 82 comprises a microscope. Magnification lens 82 and camera 90 are arranged such that the deformation zone 3 is within a field-of-view (FOV) 85 of the camera unit and thus images of the plastic deformation of the subject material 1 occurring in the deformation zone 3 may be captured by camera unit 80. As described above, the transparent plate 26 of workpiece testbed 20, positioned between camera unit 80 and the subject material 1, projects the deformation zone 3 as a 2D image within the FOV 85 of camera unit 80. Camera unit 80 may capture images of the deformation zone 3 in the visible, infra-red (IR), and ultra-violet (UV) portions of the electromagnetic spectrum.

Magnification lens 82 provides the camera unit 80 with a spatial resolution as low or lower than 0.5 micrometers (μm) per pixel. Additionally, camera 90 has a high time-resolution of up to or exceeding 50,000 frames per second (fps). The high-speed of camera 90 allows camera unit 80 to capture plastic flow of the subject material 1 in the deformation zone 3 at elevated strain rates such as strain rates up to 10³ (/s) and 10⁴ (/s). In some embodiments, camera unit 80 is configured to employ techniques such as multi-colored pulsed laser illumination and “dual-frame” operation to achieve an extremely high time-resolution of up to one million fps without sacrificing spatial resolution.

As described above, camera unit 80 may capture imaging data from any portion of the electromagnetic spectrum. In some embodiments, camera unit 80 may capture only visual imaging data of the deformation zone 3 at a high spatial- and temporal-resolution, while in other embodiments the camera unit 80 may also capture thermal imaging data of the deformation zone 3. In this manner, infrared thermography may be utilized to capture the temperature distribution across the deformation zone 3 during the cutting process. For example, in some embodiments, camera unit 80 may comprise a temperature sensor such as an infra-red sensor. In other embodiments, the subject material 1 may be at least partially coated with a temperature-sensitive paint such that temperatures within the deformation zone 3 are captured in the images captured by camera unit 80. The imaging data (visual image data, thermal image data, etc.) is outputted to the computer system 100 as an image sequence output 92 of the camera unit 80.

In this exemplary embodiment, computer system 100 generally includes a processor 102 (which may be referred to as a central processor unit or CPU) that is in communication with one or more memory devices 106, and input/output (I/O) devices 108. The processor 102 may be implemented as one or more CPU chips. The memory devices 106 of computer system 100 may include secondary storage (e.g., one or more disk drives, etc.), a non-volatile memory device such as read only memory (ROM), and a volatile memory device such as random-access memory (RAM). In some contexts, the secondary storage ROM, and/or RAM comprising the memory devices 106 of computer system 100 may be referred to as a non-transitory computer readable medium or a computer readable storage media. I/O devices 108 may include printers, video monitors, liquid crystal displays (LCDs), touch screens, keyboards, keypads, switches, dials, mice, and/or other well-known input devices. Although shown as including a single CPU 102, and a single memory device 106, it may be understood that computer system 100 may include a plurality of separate CPUs 102, memory devices 106, and I/O devices 108. It may also be understood that computer system 100 may be embodied in a networked computing system such as a cloud computing environment in which, for example, components of computer system 100 are executed and/or stored in the cloud rather than locally on a single computer.

It is understood that by programming and/or loading executable instructions onto the computer system 100, at least one of the CPU 102, the memory devices 106 are changed, transforming the computer system 100 in part into a particular machine or apparatus having the novel functionality taught by the present disclosure. Additionally, after the computer system 100 is turned on or booted, the CPU 102 may execute a computer program or application. For example, the CPU 102 may execute software or firmware stored in the memory devices 106. During execution, an application may load instructions into the CPU 102, for example load some of the instructions of the application into a cache of the CPU 102. In some contexts, an application that is executed may be said to configure the CPU 102 to do something, e.g., to configure the CPU 102 to perform the function or functions promoted by the subject application. When the CPU 102 is configured in this way by the application, the CPU 102 becomes a specific purpose computer or a specific purpose machine.

Computer system 100 is configured to receive the force sensor output 62 from force sensor module 60 and the image sequence output 92 from the camera unit 80 and determine one or more constitutive parameters, including deformation-related parameters, of the subject material 1 and associated with a constitutive model or law. In this exemplary embodiment, computer system 100 is configured to quantitatively extract full-field information of the material deformation and flow kinematics of subject material 1 (as material 1 is engaged by cutting tool 42) in terms of displacement, velocity, strain, and strain rate fields at high spatial- and temporal-resolution.

Particularly, computer system 100 is configured to apply an image correlation method to the image sequence output 92 received from camera unit 80 to extract constitutive parameters of the subject material 1. For example, referring to FIG. 9, an embodiment of an image correlation module 110 of the computer system 100 is shown. It may be understood that image correlation module 110 may be embodied in software storable on memory devices 106 and executable by the CPU 102 of computer system 100. In this exemplary embodiment, image correlation module 110 receives the image sequence output 92 from camera unit 80 as an image sequence 112. An image correlation algorithm 113 is applied to the image sequence 112 by the image correlation module 110 to produce a velocity field sequence 114. In some embodiments, the image correlation algorithm 113 comprises a Fast Fourier Transform (FFT) image correlation method such as Particle Image Velocimetry (PIV). The velocity field sequence 114 is thus associated with or obtained from the image sequence 112.

In this exemplary embodiment the image correlation algorithm 113 comprises a PIV method in which a displacement field is determined by first overlapping an artificial grid onto the image sequence 112 and selecting an interrogation window surrounding a grid point of the artificial grid. Then, for each grid point of the artificial grid, cross-correlation is performed between the interrogation window of consecutive images of the image sequence 112. Not intending to be bound by any particular theory, the cross-correlation between interrogation windows may be determined from Equation (1) below where x-y represents pixel location, f(x,y) represents the interrogation window corresponding to the first image of the image sequence 112, g(x,y) represents the interrogation window corresponding to the second image of the image sequence 112, δx and δy represent displacement of the interrogation window g(x,y) with respect to f(x,y):

$$f * g ( δ x , δ y ) = {\sum }_{i} {\sum }_{j} f ( x , y ) * g ( x + δ x , y + δ y ) \qquad ( 1 )$$

In this exemplary embodiment, the displacement corresponding to the maximum value of correlation is taken as the “true” displacement of the interrogation window g(x,y). The displacement field for every image frame of the image sequence 112 may then be determined by performing a similar analysis on every window of every image frame. In this manner, a full-field displacement data output may be obtained by the image correlation module 110 from the image sequence 112 using the algorithm 113. It may be understood that PIV methods generally do not provide specific velocity of every marker, and instead, the local velocity of a small area (e.g., the interrogation window) of the measurement plane is calculated.

Deformation-related parameters of the material subject 1 such as velocity, strain, and strain rate may be obtained by the computer system from the displacement data output. Additionally, a velocity field sequence 114 associated with the image sequence 112 may be obtained from the displacement data output and the time interval between consecutive images of the image sequence 112. Strain-related data (e.g., strain, strain rate) including an effective plastic strain rate field 116 of subject material 1 may be determined from the velocity fields (u, v) of the velocity field sequence 114 obtained by the image correlation module 110 from the image sequence 112. Not intending to be bound by any particular theory, strain-related parameters 116 of subject material 1 may be determined from Equation (2) below where, \dot{ε} represents the effective plastic strain rate field, \dot{ε}ₓₓ represents the derivative (du/dx), \dot{ε}_{yy} represents the derivative (dv/dy), and γ represents

$$( {\dot{ε}}_{yy} = \frac{dv}{dx} + \frac{du}{dy} ) : \dot{ε} = \sqrt{\frac{4}{9} ( \frac{1}{2} [ {( {\dot{ε}}_{xx} - {\dot{ε}}_{yy} )}^{2} + {\dot{ε}}_{xx}^{2} + {\dot{ε}}_{yy}^{2} ] + \frac{3}{4} {\dot{γ}}^{2} )} \qquad ( 2 )$$

The effective plastic strain field of subject material 1 may be obtained by integrating the obtained strain rate field (\dot{ε}) as a path integral.

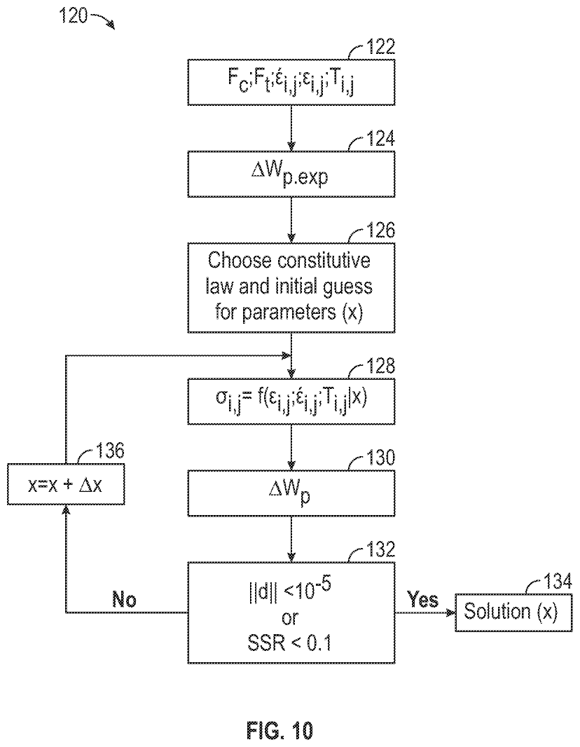

Referring now to FIG. 10, an embodiment of a parameter estimation module 120 of the computer system 100 is shown. It may be understood that parameter estimation module 120 may be embodied in software storable on memory devices 106 and executable by the CPU 102 of computer system 100. As used herein, subscripts i and j refer to pixel i and frame j. Additionally, it may be understood that for the most general case of thermoviscoplastic materials the constitutive model is generally given by σ=ƒ(ε, \dot{ε}, T) where (σ) is the flow stress, (f) represents the functional form of the constitutive model (e.g., Johnson-Cook model, Mechanical Threshold Stress model) whose parameters are unknown and are to be determined by parameter estimation module 120. As will be described further herein, parameter estimation module 120 of computer system 100 is generally configured to identify constitutive parameters denoted by the vector x that, for every pair of consecutive frames (e.g., j and j+1), leads to a predicted plastic work that closely matches the measured plastic work.

Initially, parameter estimation module 120 receives data inputs 122 from both the force sensor unit 60 and the camera unit 80 of system 10. In this exemplary embodiment, data inputs 122 include the cutting force (Fc) and thrust force (Ft) measured by the force sensor unit 60, strain at a given pixel location (ε_{i,j}), strain rate at a given pixel location (\dot{ε}_{i,j}), and potentially temperature at a given pixel location (T_{i,j}) captured by the camera unit 80. From data inputs 122, parameter estimation module 120 is configured to determine an experimentally observed plastic work 124 of the subject material 1.

As an example, and not intending to be bound by any particular theory, the predicted plastic work between two consecutive images (ΔW_{p,j}) may be determined from Equation (3) below as a function of unknown material parameters and measured data, where (Aᵢ) represents the pixel area, w represents the thickness of subject material 1 (sample dimension normal to the viewing plane of camera unit 80), (δε_{i,j}) represents the plastic strain increment between consecutive frames at a material point located at pixel i, and (σ_{i,j}) is the flow stress located at pixel i:

$$Δ {W}_{p , j} = {\sum }_{i = 1}^{I} {σ}_{i , j} {δε}_{i , j} {A}_{i} w = {\sum }_{i = 1}^{I} f ( {ε}_{i , j} ; {\dot{ε}}_{i , j} ; {T}_{i , j} \vert x ) {δε}_{i , j} {A}_{i} w \qquad ( 3 )$$

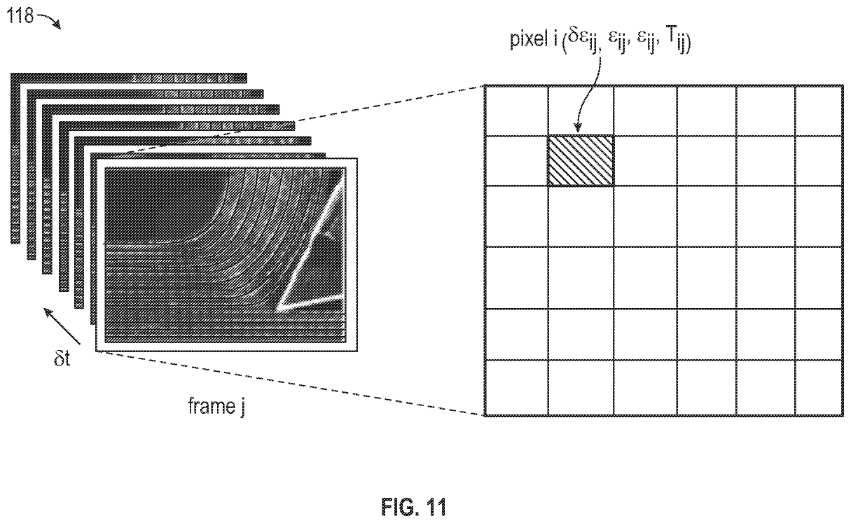

Referring briefly to FIG. 11, full-field data notation for each pixel i of each displacement field frame j of an exemplary displacement field sequence 118 produced by the image correlation module 110 of computer system 100 from the image sequence 112. FIG. 10 illustrates how each frame j of the displacement field sequence 118 is made up of a plurality of pixels i, where each pixel i includes information about a specific effective plastic strain (ε_{i,j}), effective plastic strain rate (\dot{ε}_{i,j}), and effective plastic strain increment (δε_{i,j}).

Referring again to FIG. 10, as part of this example, and again not intending to be bound by any particular theory, the experimentally observed plastic work (ΔW_{p,exp,j}) may be obtained from the total external work (ΔW_{external,j}) and frictional work (ΔW_{friction,j}) resulting from sliding contact between the cutting tool 42 and subject material 1 in accordance with Equations (4) and (5) below where the symbol (Δ) indicates that the work considered is the incremental work done between two consecutive images, (V₀) represents the deformation velocity of the subject material 1, (V_{c}) represents the chip velocity which may be obtained by image correlation module 110 using, e.g., PIV analysis, (F_{ƒ}) represents the frictional force parallel to the deformation tool-chip contact, (δt) represents the inter-frame time between consecutive frames, and (α) represents the rake angle:

$$Δ {W}_{p , exp , j} = Δ {W}_{external , j} - Δ {W}_{friction , j} = ( {F}_{c} {V}_{0} - {F}_{f} {V}_{c} ) δ t \qquad ( 4 )$$

$${F}_{f} = {F}_{c} sin α + {F}_{t} cos α \qquad ( 5 )$$

Following the determination of the experimentally observed plastic work 124, a constitutive law or model 126 along with initial estimates of one or more constitutive parameters (x) of the subject material 1 are chosen by the parameter estimation module 120 based on, for example, the type of subject material 1. In an example where subject material 1 comprises an alloy containing 70% copper and 30% zinc, parameter estimation module 120 will select a constitutive law 126 and an associated set of initial estimates of the one or more constitutive parameters (x) based on known information pertaining to this type of alloy and materials that are similar in composition and make-up to the alloy. With the constitutive model 126 chosen, parameter estimation module 120 is configured to determine the flow stress 128 of subject material 1 at each pixel (i) of each image frame (j). The determination of flow stress 128 by parameter estimation module 120 may be based on Equations (4) and (5) above. Additionally, with the flow stress 128 of subject material 1 determined, parameter estimation module 120 is configured to determine the predicted plastic work 130. The determination of predicted plastic work 130 by parameter estimation module 120 may be based on Equation (3) above.

Having determined both the experimentally observed plastic work 124, and the predicted plastic work 130, the predicted plastic work 130 is compared to the experimental plastic work 124 at a comparison block 132 of the parameter estimation module 120. Comparison block 132 may include determining the sum of squared residuals (SSR) between the predicted plastic work 130 and the experimental plastic work 124 for a given set of frames and a set of constitutive parameters (x). For example, if the SSR is less than 0.1, the constitutive parameter set (x) used to determine the predicted plastic work 130 is taken as the solved or determined constitutive parameter 134. However, if the SSR is equal to or greater than 0.1, then the constitutive parameter set (x) used to determine the predicted plastic work 130 is replaced with a new constitutive parameter 136 which is equal to sum of the old constitutive parameter set (x) and an incremental value (Δx). A new flow stress 128 and a new predicted plastic work 130 may be determined by the parameter estimation module 120 based on the new constitutive parameters 136. Again, the new predicted plastic work 130 may be compared with the experimentally observed plastic work 124 at the comparison block 130 to determine if the new constitutive parameter set (x) should be selected by the module 120 as the selected constitutive parameters 134.

To state in other words, in some embodiments, comparison block 130 is performed iteratively to minimize an error (e.g., SSR) until the error between the experimentally observed plastic work 124 and the predicted plastic work 130 is below a predefined error threshold (e.g., SSR<0.1). Not intending to be bound by any particular theory, minimization of error in the form of SSR may be expressed in accordance with Equation (6) below:

$${min}_{x} SSR = {\sum }_{j = 2}^{J} ( {\sum }_{i = 1}^{I} f ( {ε}_{i , j} ; {\dot{ε}}_{i , j} ; {T}_{i , j} \vert x ) {δε}_{i , j} {A}_{i} w - Δ {W}_{p , exp , j} ) \qquad ( 6 )$$

It may be understood that unlike other methodologies like Virtual Fields Method (VFM), Equation (6) does not require a user to select an “artificial” virtual velocity field and instead, each of the parameters of Equation (6) have direct physical significance. Parameter estimation module 120 is configured to apply an optimization algorithm to the objective function (Equation (6) in this example) to achieve a globally optimum solution to the objective function. In some embodiments, parameter estimation module 120 may tailor an otherwise generic optimization algorithm based on the constitutive law selected by the parameter estimation module 120. In some embodiments, optimization algorithms like Newton-based algorithms (algorithms based on Newton's method), such as Newton-Raphson algorithms, are utilized to solve Equation (6) which are specifically tailored for handling different types of constitutive models.

The Newton-based algorithm employed to solve Equation (6) may be associated with the particular constitutive model 126 and thus may vary depending on the given constitutive model 126 that is applied. Such Newton-based algorithms may have a relatively superior rate of convergence and minimal input parameters when compared to other algorithms such as Nelder-Mead or simulation-based algorithms. Particularly, Newton-based algorithms generally start with a set of initial estimates of the parameters to be solved and iteratively update the parameters so that the objective function (e.g., SSR) is minimized. As an example, and not intending to be bound by any particular theory, a Newton-based algorithm for solving Equation (6) may be expressed in accordance with Equation (7) below, where (k) represents the iteration number, (μₖ) represents the step size, (dₖ) represents the direction vector, (Hₖ) represents the Hessian objective function, and (gₖ) represents the Jacobian objective number:

$${x}_{k + 1} = {x}_{k} - {μ}_{k} {d}_{k} ; {d}_{k} = {H}_{k}^{- 1} {g}_{k} ; {μ}_{k} = arg {min}_{μ} SSR ( {x}_{k + 1} ) \qquad ( 7 )$$

The step size (μₖ) may be optimized using either a simple line search or a quadratic interpolation scheme. In this exemplary embodiment, the algorithm of Equation (7) is terminated when either the SSR is less than 0.1 or when the norm of the direction vector (∥d∥) is less than a predefined threshold value (e.g., 10⁻⁵). It may be understood that these threshold values may vary in other embodiments. Alternatively, the algorithm of Equation (7) may be terminated when the Euclidean norm of the difference between two consecutive solutions (∥xₖ₊₁−xₖ∥) becomes less than a predefined threshold value (e.g., 10⁻⁵). As a further alternative, the algorithm of Equation (7) may be terminated when the Euclidean norm of the gradient (∥gₖ∥₂) reaches or exceeds a predefined threshold value.

Unlike other algorithms like Nelder-Mead based algorithms, which have difficulty even converging to a local minimum in some applications, Newton-based algorithms such as Equation (7) are guaranteed to converge to the global optimum solution when the objective function is convex. Additionally, even under a more general setting of a nonconvex objective function, Newton-based algorithms may be tailored (e.g., through the use of a Levenberg-Marquardt modification) in a manner that guarantees an improved or minimized SSR in every iteration. Thus, Newton-based algorithms executable by the parameter estimation module 120 may maximize the accuracy of the selected constitutive parameters 136 outputted or produced by the module 120. It may also be understood that, under an arbitrary constitutive law or model, a series of analyses may be conducted by parameter estimation module 120 for a given constitutive model 126 to identify key structural properties of the subject material 1 that can be used to construct algorithms with guaranteed performance. Thus, Newton-based algorithms may not be employed for each kind of constitutive model 126.

In some embodiments, possibly in lieu of the Newton-based algorithms described above, the parameter estimation module 120 may execute other optimization algorithms to globally optimize an objective function such as spatial Branch-and-Bound (sB&B) algorithms. For example, parameter estimation module 120 may apply sB&B algorithms to determine the selected constitutive parameters 134. sB&B algorithms are suitable for solving complex, non-convex problems with multiple parameters. In general, sB&B algorithms are “divide-and-conquer” algorithms that convert the problem's search space into a rooted search tree, where convex under-estimators of the objective function are computed at each node within a specified parameter space range and solved using local convex optimization techniques (e.g., Newton-based algorithms and gradient descent). With each iteration, the problem is divided into multiple sub-problems by partitioning the parameter space into smaller feasible regions until a lower bound (e.g., the minima of the convex under-estimator) and an upper bound (e.g., the original function value at minima of under-estimator) of the function's optimal value fall within a predefined tolerance. Unlike other algorithms, sB&B algorithms allow the problem to be solved to global optimality, which may overcome at least some reliability issues in material parameter estimation, including non-unique material parameter estimates as well as the dependency of final material parameter estimates on the initial estimates. Additionally, sB&B algorithms may be utilized when an arbitrary constitutive law or model 126 is applied by the parameter estimation module 120.

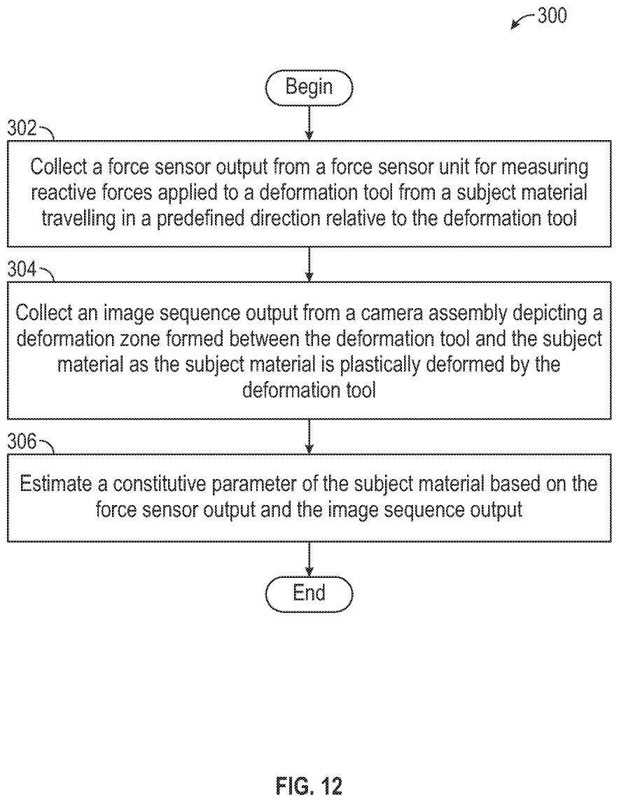

Referring to FIG. 12, an embodiment of a method 300 for determining constitutive parameters for a subject material is shown. Beginning at block 302, method 300 comprises collecting a force sensor output from a force sensor unit for measuring reactive forces applied to a deformation tool from a subject material travelling in a predefined direction relative to the deformation tool. In some embodiments, block 302 comprises collecting the force sensor output 62 produced by the force sensor unit 60 shown in FIG. 1, the force sensor unit 60 for measuring reactive forces applied to the deformation tool 42 shown in FIG. 1 from the subject material 1.

At block 304, method 300 comprises collecting an image sequence output (which may contain visual imaging data and/or other types of imaging data like thermal imaging data) from a camera unit depicting a deformation zone formed between the deformation tool and the subject material as the subject material is plastically deformed by the deformation tool. In some embodiments, block 304 comprises collecting the image sequence output 92 from the camera unit 80 shown in FIG. 1 depicting the deformation zone 3 formed between the deformation tool 42 and the subject material 1. At block 306, method 300 comprises estimating a constitutive parameter of the subject material based on the force sensor output and the image sequence output. The constitutive parameter may comprise at least one of a yield strength, hardening modulus, strain-rate sensitivity, strain-hardening, and thermal-softening of the subject material. In some embodiments, block 306 comprises estimating a constitutive parameter of the subject material 1 shown in FIG. 1 based on the force sensor output 62 and the image sequence output 92.

Experiments were conducted for determining constitutive parameters of different subject materials. It may be understood that the following experiments described herein are not intended to limit the scope of this disclosure and upon the embodiments described above and shown in FIGS. 1-12. Particularly, wedge experiments were carried out with OFHC (Oxygen-Free High Thermal Conductivity) copper (Cu) and a Bi—Pb—Sn—Cd based low melting-point alloy as model material systems. These materials were chosen for their distinctive plastic flow properties. Results of these experiments are presented below, followed by validation of the approach using standard tension and compression experiments.

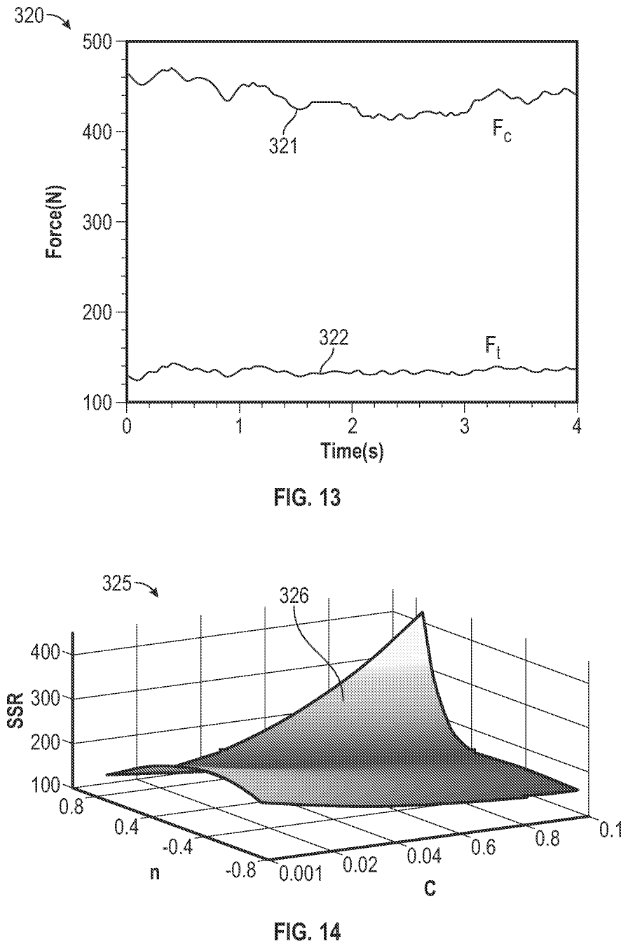

Referring to FIG. 13, a graph 320 is shown illustrating force as a function of time for the wedge experiments where a subject material comprising copper was displaced at a deformation velocity (V₀) of approximately four millimeters per second (mm/s). Particularly, graph 320 illustrates cutting forces (F_{c}) 321 and thrust forces (Fₜ) 323 captured during the wedge experiments.

As an example, and not intending to be bound by any particular theory, OFHC copper is well described by the Johnson-Cook (JC) constitutive model which may be expressed in accordance with Equation (8) below, where (ε) represents effective plastic strain, (\dot{ε}) represents effective plastic strain rate, (\dot{ε}₀) represents a reference strain rate (set at 10⁻⁵/s in this example), (Tₘ) represents melting temperature, (T₀) represents ambient (room) temperature, and constitutive parameters (A), (B), (C), (n), and (m) represent yield strength (MPa), hardening modulus (MPa), strain-rate sensitivity, strain-hardening and thermal-softening coefficients, respectively:

$$σ = ( A + {B ( ε )}^{n} ) [ 1 + C log \frac{\dot{ε}}{{\dot{ε}}_{0}} ] [ 1 + {( \frac{T - {T}_{0}}{{T}_{m} - {T}_{0}} )}^{m} ] \qquad ( 8 )$$

Temperature estimates as well as preliminary thermal imaging measurements showed that the temperature rise in the deformation zone under low V₀ conditions used in the study is no more than 10° C. Given this, thermal effects could be ignored and the number of constitutive parameters reduced to four: (A), (B), (C), and (n). However, a complication arose in that the resultant SSR objective function was non-convex (multimodal), which posed challenges in identifying the optimal constitutive parameters using common optimization algorithms.

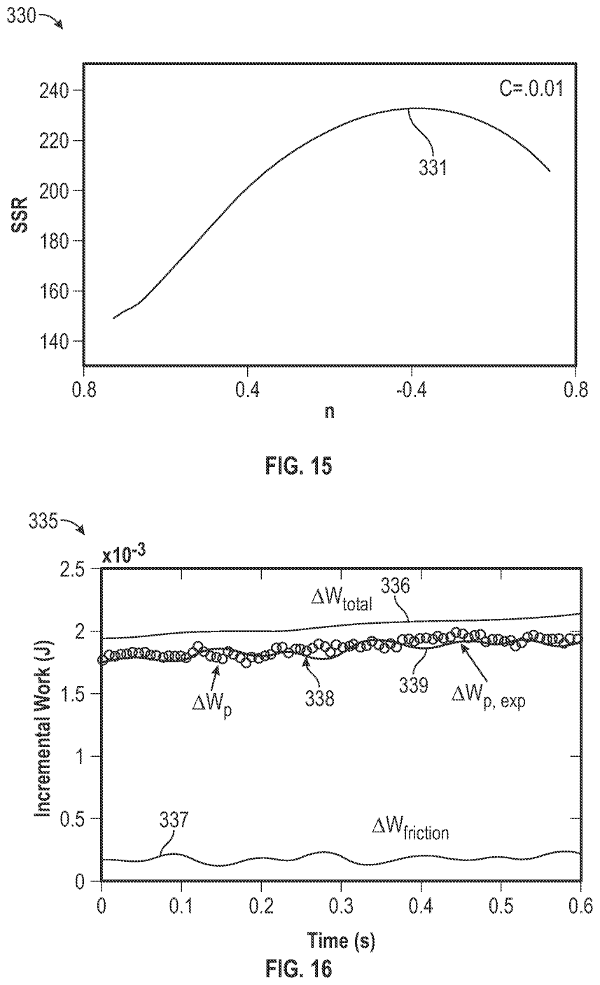

As an example, and referring now to FIGS. 14 and 15, graphs 325 and 330 are shown. Particularly, three-dimensional (3D) graph 325 illustrates SSR 326 determined as a function of both (C) and (n) constitutive parameters for fixed values of (A) (A=60 MPa in this example) and (B) (B=260 MPa) constitutive parameters, where the contour of SSR 326 shows the non-convex nature of the SSR 326. For convenience, graph 330 also illustrates SSR 331 as a function of parameter (n) with parameter (C) held constant. Although conventional search-optimization algorithms may result in convergence to a stationary point, such algorithms typically do not guarantee a solution that is optimal in the “global” sense. Instead, the obtained solution will most likely correspond to a local minimum in the neighborhood of the starting point. This means that the final parameter estimates not only depend on their initial guesses (starting point) but also may not represent the true material behavior.

To circumvent the numerical issue of failing to arrive at a globally optimal solution, the non-convex problem was reformulated into a set or sequence of convex sub-problems using an approach similar to a generalized Benders decomposition. This approach exploited the structure of the objective function by temporarily fixing a few variables, referred to as complicating variables, to reduce the problem to a convex quadratic program, parameterized by the complicating variable vector. For the current objective function for the JC constitutive model, this was achieved by selecting constitutive parameters (C) and (n) as the complicating variables, which reduced the problem to a convex quadratic problem with remaining variables (A) and (B). A grid-based optimization scheme was used to solve for the (A) and (B) constitutive parameters where complicating variables were parameterized and optimal (A) and (B) constitutive parameters were determined for each combination of (C) and (n) constitutive parameters by implementing a Newton-based algorithm with an optimized step size. In this example, a stopping criterion, (∥xₖ₊₁−xₖ∥₂; 10⁻⁵), was used to terminate the algorithm.

This process involved, first, generating a coarse (C) versus (n) grid, with (C) in the range of (0.001, 0.04) with a resolution of 0.001 and (n) in the range of (0.2, 0.8) with a resolution of 0.01, and then finding the approximate (C) and (n) where SSR is minimized. The parameter bounds for (C) and (n) were chosen based on the known for common metals. In this experiment, the least SSR for this realized grid was found to be at (C)=0.005 and (n)=0.55. The (C) versus (n) grid was then subsequently refined by increasing the resolution by 10-fold in the range of (C)=(0:004; 0:006) and (n)=(0:54; 0:56); and the process was repeated again to further improve the solution and obtain final estimates of the constitutive parameters. This approach yielded the following parameter estimates: (A)=40:94 MPa, (B)=469:2 MPa, (C)=0:0052, and (n)=0:549 for copper. This analysis considered full-field flow data (strain and strain rate) obtained from an image sequence of 450 frames (approximately 1.5 milliseconds (ms) inter-frame time) and corresponding force data acquired from an experiment conducted at V₀=4 mm/s and α=20°.

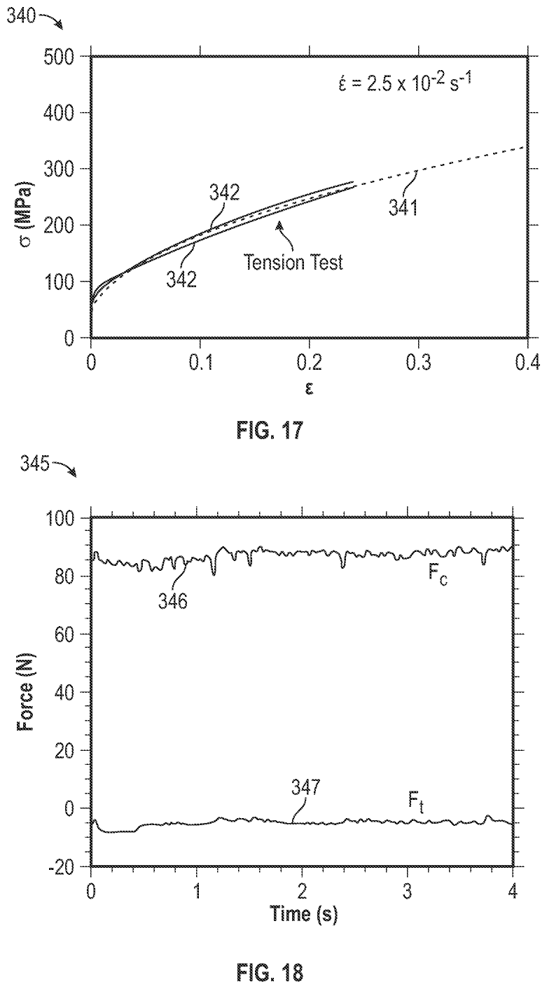

Referring to FIGS. 16 and 17, graphs 335 and 340 are shown. Particularly, graph 335 comprises a time-plot of incremental work performed during the study. Graph 335 includes total work (ΔWₜₒₜₐₗ) 336, friction work (ΔW_{frrction}) 337, predicted plastic work (ΔWₚ) (circles 338 in graph 335), and measured work (ΔW_{p,exp}) 339. Total work 336, friction work 337, and measured work 339 (measured work 339 equals the difference between the total work 336 and friction work 337) were calculated from forces plotted over a time period. On the other hand, the predicted plastic work 338 was based on the full-field deformation data and the estimated JC constitutive parameters. The predicted plastic work 338 closely matched the measured work 339 at all the time instances, indicating that the parameters estimated are indeed the optimal parameters.

Comparison with uniaxial tension tests was performed to provide another check for the parameter estimates, as shown particularly in graph 340. Particularly, graph 340 illustrates a first stress-strain curve 341 (dashed line) obtained using the estimated constitutive parameters and a second set of stress-strain curves 342 (solid lines) obtained from uniaxial tension tests on the same subject material (copper). The first stress-strain curve 341 generally matches the second set of stress-strain curves 342, demonstrating the estimated constitutive parameters indeed represent the true material behavior.

Robustness of the proposed approach was further verified by conducting multiple experiments under different, t₀ and V₀ conditions. Results from these experiments are summarized below in Table 1:

TABLE 1

| | α = 15° | α = 20° | α = 20° | α = 40° | Tension |
|---|---|---|---|---|---|
| Parameters | V₀ = 4 mm/s | V₀ = 4 mm/s | V₀ = 12 mm/s | V₀ = 4 mm/s | tests |
| A (MPa) | 40.94 | 42.13 | 45.37 | 41.61 | 41.2 |
| B (MPa) | 469.2 | 478.8 | 464.8 | 471 | 476.8 |
| C | 0.0052 | 0.0048 | 0.0061 | 0.0056 | 0.0056 |
| n | 0.549 | 0.561 | 0.525 | 0.522 | 0.57 |

The same grid-based optimization approach was used to estimate the parameters by analyzing 500 or more frames for each experimental condition. The general match between estimated parameters from multiple experiments demonstrated geometry (e.g., wedge inclination angle) independence of the estimated parameters, and suggested the proposed experimental/numerical approach could be used to extract reliable and quantitative stress-strain information, equivalent to that of the standard material tests. Equally importantly, the results also showed that neither steady-state laminar plastic flow nor a thin uniform shear plane assumption are prerequisites for the parameter analysis.

A similar study was carried out with the low melting-point alloy characterized by high rate sensitivity. Referring to FIG. 18, a graph 345 is shown illustrating the cutting forces (F_{c}) 346 and thrust forces (Fₜ) recorded during these experiments. Constitutive behavior of this alloy was modeled using Anand's viscoplastic model, an internal variable-based model that is used to describe the rate-dependent behavior of low melting-point solder alloys at high homologous temperatures. Note that, given the low melting point of the alloy (Tₘ=70° C.), room temperature corresponded to a high homologous temperature of ˜0.87 for this alloy.

Without intending to be bound by any particular theory, Anand's model may be expressed in accordance with Equations (9) and (10) below, where (σ*) represents the saturation flow stress, (R) represents the universal gas constant while the remaining parameters (outside of ε, \dot{ε}, and T) are unknown constitutive parameters:

$${σ}^{*} = {\tilde{s} [ \frac{\dot{ε}}{A} exp ( Q / RT ) ]}^{n} {sinh}^{- 1} [ {( \frac{\dot{ε}}{A} exp ( Q / RT ) )}^{m} ] \qquad ( 9 )$$

$$σ = {σ}^{*} - {[ {( {σ}^{*} - {cs}_{0} )}^{( 1 - a )} + ( a - 1 ) {{ch}_{0} ( {σ}^{*} )}^{- a} ε ]}^{\frac{1}{1 - a}} \qquad ( 10 )$$

In the absence of thermal effects, parameters (Q) and (A) cannot be estimated separately. Therefore, a combined term (exp(Q/RT)/A), which was also referred to as (A′) (1/s), was used. To further simplify the constitutive law, the parameter (c) was combined with parameters (s₀) and (h₀) to provide two combined parameters (cs₀) and (ch₀).

Similar to the JC model experiment described above, the applicability of common optimization algorithms for solving Equation (6) for the case of Anand's model is again limited by the highly non-convex nature of the underlying objective function. While grid-based optimization scheme was shown to be an effective method for solving the problem to global optimality (within resolution limits set by parameterization) for the case of the JC model experiment, a similar implementation for Anand's model is not practical (time-wise) because of the large number of parameters (seven for Anand's model versus four for JC model). This issue was addressed using a two-step approach: first, sample space of the parameter set was explored in order to identify the approximate location of the global minimum by taking approximately hundred random initial guesses for the parameters. Parameter bounds for the initial estimates of the constitutive parameters were chosen based on typical values known in the art for low melting-point solder alloys. However, constitutive parameter (n) on the other hand was constrained between 0 and −1, given the strain-softening behavior of the alloy.

A key observation emerged from this analysis is the high sensitivity of the objective function on constitutive parameter (n). In particular, when (n) >−0.7, the algorithm resulted in constitutive parameter estimates with a relatively high SSR, with estimated constitutive parameters also being highly dependent on the initial estimate—a consequence of algorithm converging to local minima. The parameter space, (n)<−0.7, on other hand is characterized by low SSR values (one order lower than for (n) >−0.7) and consistent convergence to similar parameter estimates regardless of the initial estimate.

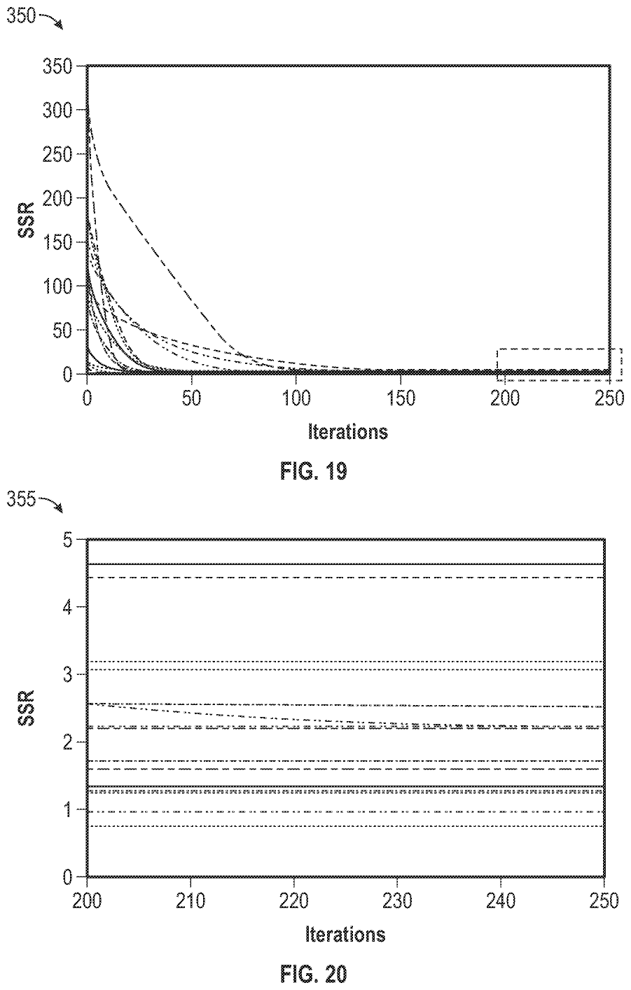

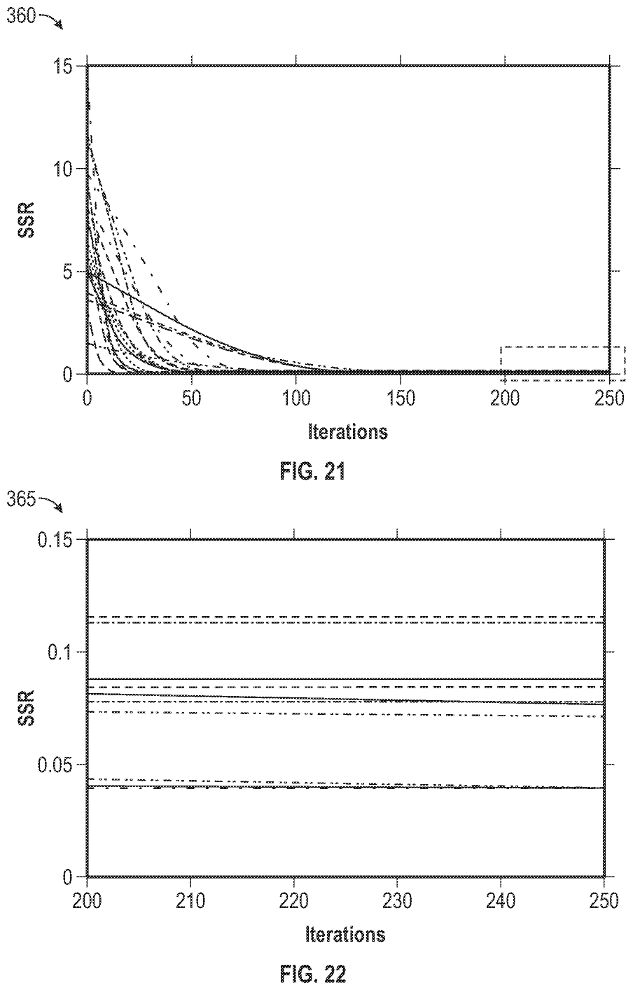

Referring to FIGS. 19-22, graphs 350, 355, 360, and 365, respectively, are shown which depict convergence behavior of the objective function (SSR) for the case of Anand's model in this experiment from zero to approximately 250 iterations. Particularly, graphs 350 and 355 illustrates the convergence of SSR for a plurality of different initial estimates in the ((n) >−0.7) parameter space (graph 355 being zoomed-in on iterations 200-250). Conversely, graphs 360 and 365 illustrates the convergence of SSR for a plurality of different initial estimates in the ((n) <−0.7) parameter space (graph 365 being zoomed-in on iterations 200-250). It is clear from graphs 350-365 that the resultant SSR (˜0:05 to 0.1) for (n) <−0.7 is significantly smaller compared to the corresponding SSR range (˜1 to 5) for (n) >−0.7.

In view of these results, a second step was performed in which a more rigorous search was conducted in the parameter space (n∈(−0.7,−1)) by parameterizing (n) with a resolution of 0.01. The minimization problem for each realization of (n) was solved by taking at least twenty random initial estimates for the remaining parameters and using the Newton-based algorithm. Parameters corresponding to the least SSR from all the initial estimates were considered to be the best estimate for a particular (n). Neighborhood of the n (=−0.89) having the least SSR (=0.04) was then refined again 10-fold to further improve resolution of the solution.

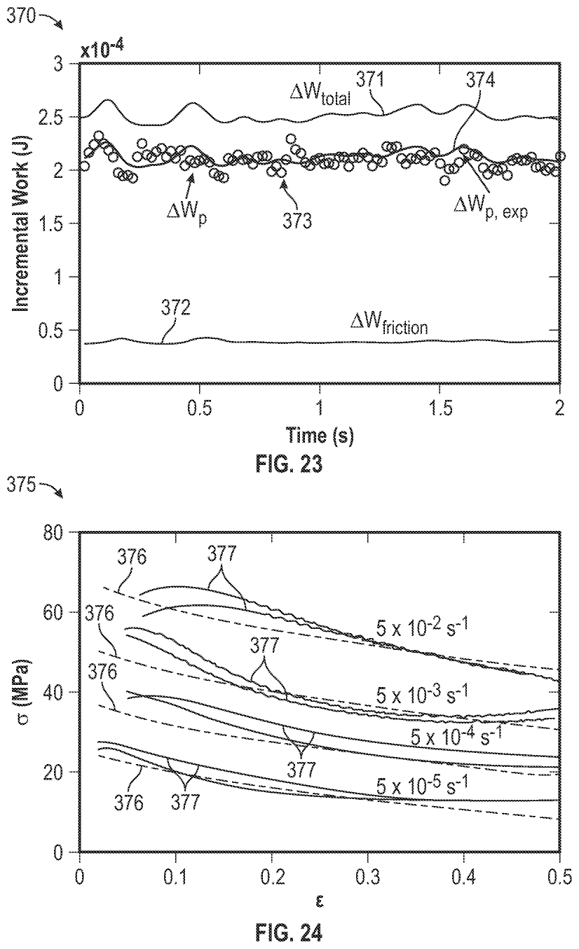

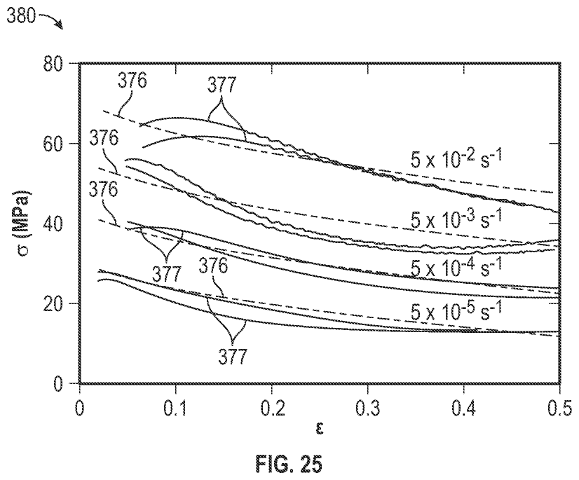

Referring to FIGS. 23-25, graphs 370, 375, and 380, respectively, are shown pertaining to the performance and behavior of the constitutive parameters estimated using the above approach. Particularly, graph 370 depicts total work (ΔWₜₒₜₐₗ) 371, friction work (ΔW_{frriction}) 372, predicted plastic work (ΔWₚ) (circles 373 in graph 370), and measured work (ΔW_{p,exp}) 374. Graph 370 depicts a general match between the measured work 374 and the predicted plastic work 373 based on the best parameter estimates from an experiment where V₀ equals approximately 0.3 mm/s, the rake angle (α) equals approximately 20°, and considering 100 time instances.

Graph 375 illustrates predicted stress-strain curves 376 (dashed lines in graph 375) plotted on top of experimentally determined stress-strain curves 377 (depicted as solid lines in graph 375) at different strain rates in the range of 10⁻⁵ to 10⁻²/s. Two compressive stress-strain curves 377 are shown at each strain rate to illustrate the ‘spread’ in the data from sample to sample. The parameters estimated from flow field measurements are shown to capture the overall behavior of the alloy well, including the high strain-rate dependence and softening behavior with strain. While there is some observable deviation between the predicted (376) and experimental (377) curves in the low-strain regime (ε<1), further analysis showed that this deviation is generally not a consequence of sub-optimal parameter estimates but that of the choice of the constitutive model itself.

For example, graph 380 illustrates predicted stress-strain curves 381 and experimentally derived stress-strain curves 382 at different strain rates. Unlike predicted stress-strain curves 376 shown in graph 375, predicted stress-strain curves 381 were obtained by conventional curve-fitting of Anand's model to the compression test data. A similar deviation in the fit from experimental data (curves 382) is evident at low strains, suggesting that the fit accuracy is limited by the model choice itself and not the parameter estimation method. In fact, a direct comparison of the parameter estimates with those from conventional curve-fitting of experimental stress-strain data revealed that they are similar.

Lastly, it should be mentioned that constitutive parameter estimation via curve-fitting of stress-strain data from multiple uniaxial deformation tests is still subject to non-uniqueness issues noted in this study. That is, the objective function (e.g., SSR) that curve-fitting algorithms seek to minimize can be, and often are, non-convex, which means that local optimization algorithms like the Levenberg-Marquardt algorithm that are typically used for conventional curve-fitting applications cannot guarantee globally optimal solutions by default unless some intrinsic mathematical property of the problem is used to overcome this issue. This, for example, may at least partially explain the broad spectrum of parameters reported for a same material, especially in the case of complex highly non-linear constitutive models like Anand's model where the objective function (e.g., SSR) is highly likely to be non-convex. In this regard, the constitutive parameter estimation explored in this experimental study not only enables calibration of the entire parameter set in a single experiment but also ensures optimal/epsilon-optimal solutions through a tailored constitutive law-specific approach.

The result of this experimental study indicates the proposed experimental-computational approach of inferring constitutive parameters (e.g., metal plasticity parameters) from in situ flow field measurements can be used for determining the constitutive properties over a wide range of deformation conditions. A distinctive feature of this approach is that the entire constitutive parameter set can be determined in a single experiment (e.g., a single deformation or cutting operation) by taking advantage of the underlying heterogeneous deformation field, that is, a wide range of strains and strain rates are sampled together in a single experiment. By contrast, conventional uniaxial tests require the performance of multiple, separate experiments at different rates and temperatures to estimate constitutive parameters of a subject material. Another attractive and a unique feature of the experimental configuration is that it enables exploration of material behavior under very large plastic strains and strain rates of interest both from a scientific perspective and to a range of practical problems. Replicating such deformation conditions (especially large strains) using conventional high strain-rate testing methods is highly challenging and entails the use of exotic explosives, impact, or gas-gun firing mechanisms.

The experimental approach described herein, which integrated direct flow observations into the parameter estimation routine, represents a significant departure from previous studies that have been proposed for determining the viscoplastic behavior of materials (e.g., metals), in that the approach made no assumptions regarding flow kinematics or the deformation zone (e.g., stress and strain uniformity), nor did it require finite element simulations, including Finite Element Model Updating (FEMU) which is generally inapplicable to large-strain plasticity problems as well as other issues.

Additionally, the experimental study has also illustrated how, even in the case of a relatively simple constitutive model like Johnson-Cook, the underlying non-convex objective function (e.g., SSR) can lead to multiple or non-unique sets of constitutive parameters, depending on the choice of the initial parameter estimates. A concern with non-unique solutions is that though they may often predict roughly equivalent macroscopic flow stress under the strain and strain rate conditions over which they are calibrated, they do not offer performance guarantees when extrapolated to regimes outside the calibrated range. Moreover, this multiplicity of parameter sets also has implications when solving boundary-value problems, for they have been shown to result in very different numerical solutions for the same boundary-value problem.

Addressing this intricate issue amounts to solving the optimization problem to global optimality. Nevertheless, all inverse parameter identification methods (e.g., FEMU) exclusively rely on local search algorithms that are most likely to converge to a local minimum instead of the global minimum. For example, owing to its simplicity and ease of use, one of the most commonly adopted algorithms is the Nelder-Mead algorithm, although it has been shown that Nelder-Mead algorithm can even fail to converge to a local minimum even under favorable optimization conditions (e.g., strictly convex function with only two decision variables).

By contrast, the Newton-based algorithms explored in this experimental study have several advantages over conventional methods. For instance, Newton-based approaches are guaranteed to converge to the globally optimal solution when the objective function is convex. Even under a more general setting of a non-convex objective function, Newton-based approaches can be potentially tailored by taking advantage of intrinsic structural property of the problem so as to guarantee global optimal solution. In this experimental study, approaches have been presented to construct such tailored algorithms and demonstrate their efficacy in achieving the global optimum in the “exact” sense for the JC model, and heuristically for the case of Anand's model. In the latter regard, it should be noted that the constitutive parameter estimation methodology described herein has broad applicability and may be extended to other commonly used constitutive models like the Zerrili-Armstrong and Mechanical Threshold Stress models.

While embodiments of the disclosure have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

1. A system for determining constitutive parameters of a subject material, the system comprising:
a testbed having an external surface configured to receive the subject material to couple the subject material to the testbed;
a linear drive configured to transport the subject material, when coupled to the testbed, in a predefined direction at a predefined velocity;
a deformation tool configured to physically contact and plastically deform the subject material in response to the transportation of the subject material in the predefined direction by the linear drive;
a force sensor unit coupled to the deformation tool and configured to produce a force sensor output corresponding to reactive forces applied to the deformation tool from the subject material;
a camera unit configured to produce an image sequence output of a deformation zone formed between the deformation tool and the subject material in response to plastic deformation of the subject material by the deformation tool; and
a computer system coupled to the force sensor unit and the camera unit and comprising a parameter estimation module configured to estimate a constitutive parameter of the subject material based on the force sensor output and the image sequence output.

2. The system of claim 1, wherein the camera unit comprises a magnification lens and a camera coupled the magnification lens.

3. The system of claim 1, wherein the image sequence output at least one of visually depicts the deformation zone and thermally depicts the deformation zone.

4. The system of claim 1, wherein the camera unit comprises a thermal sensor for monitoring a temperature of the deformation zone.

5. The system of claim 1, wherein the deformation tool comprises at least one of an indenter, and a cutting tool having a cutting face configured to cut into the subject material at a predefined rake angle.

6. The system of claim 1, wherein the parameter estimation module of the computer system is configured to determine a measured plastic work based on the force sensor output and the image sequence output and a predicted plastic work based on a selected constitutive model, and to compare the measured plastic work with the predicted plastic work.

7. The system of claim 6, wherein the parameter estimation module of the computer system is configured to provide an initial estimate of the constitutive parameter, and wherein the predicted plastic work is based on the initial estimate and the image sequence output.

8. The system of claim 7, wherein the parameter estimation module of the computer system is configured to minimize an error between the predicted plastic work and the measured plastic work.

9. The system of claim 8, wherein the parameter estimation module of the computer system is configured to apply a Newton-Raphson algorithm to an objective function defining the error between the predicted plastic work and the measured plastic work to minimize the error.

10. The system of claim 8, wherein the parameter estimation module of the computer system is configured to apply a spatial Branch-and-Bound to an objective function defining the error between the predicted plastic work and the measured plastic work to minimize the error.

11. The system of claim 1, wherein the computer system comprises an image correlation module configured to apply an image correlation algorithm to the image sequence output to produce a velocity field sequence from the image sequence output.

12. The system of claim 11, wherein the image correlation module is configured to determine a plastic strain rate field of the deformation zone based on the application of the image correlation algorithm to the image sequence output.

13. The system of claim 1, wherein the constitutive parameter comprises at least one of a yield strength, a hardening modulus, a strain-rate sensitivity, a strain-hardening, and a thermal-softening of the subject material.

14. A method for determining constitutive parameters of a subject material, the method comprising:
(a) collecting a force sensor output from a force sensor unit for measuring reactive forces applied to a deformation tool from a subject material travelling in a predefined direction relative to the deformation tool;
(b) collecting an image sequence output from a camera unit depicting a deformation zone formed between the deformation tool and the subject material as the subject material is plastically deformed by the deformation tool; and
(c) estimating a constitutive parameter of the subject material based on the force sensor output and the image sequence output.

15. The method of claim 14, wherein the image sequence output at least one of visually depicts the deformation zone and thermally depicts the deformation zone.

16. The method of claim 14, wherein (c) comprises:
(c1) determining a measured plastic work based on the force sensor output;
(c2) determining a predicted plastic work based on a selected constitutive model, the image sequence output, and an initial estimate of the constitutive parameter; and
(c3) comparing the measured plastic work with the predicted plastic work.

17. The method of claim 16, wherein (c3) comprises minimizing an error between the predicted plastic work and the measured plastic work by iteratively adjusting the values of the constitutive parameters.

18. The method of claim 14, wherein (c) comprises:
(c1) selecting a constitutive law based on the identity of the subject material;
(c2) tailoring an optimization algorithm based on the selected constitutive law; and
(c3) applying the tailored optimization algorithm to an objective function defining an error between a predicted plastic work determined from the force sensor output and a measured plastic work determined from a selected constitutive model, the image sequence output, and an initial estimate of the constitutive parameter to minimize the error.

19. The method of claim 14, wherein the image sequence output depicts a strain rate of the subject material of 10² per second or greater.

20. A computer system for determining constitutive parameters of a subject material, the computer system comprising:
a processor; and
a storage device coupled to the processor and containing instructions that when executed cause the processor to:
collect a force sensor output from a force sensor unit for measuring reactive forces applied to a deformation tool from a subject material travelling in a predefined direction relative to the deformation tool;
collect an image sequence output from a camera unit depicting a deformation zone formed between the deformation tool and the subject material as the subject material is plastically deformed by the deformation tool; and
estimate a constitutive parameter of the subject material based on the force sensor output and the image sequence output.
